(19) United States
(12) Patent Application Publication
(10) Pub. No.: US 2025/0300259 A1
(43) Pub. Date: Sep. 25, 2025

(54) A METHOD OF REMOVING AND SAFE DISPOSAL OF ELECTROLYTE FROM SPENT LITHIUM-ION BATTERIES

(71) Applicant: ATTERO RECYCLING PVT. LTD., Roorkee, OT (IN)

(72) Inventors: Nitin GUPTA, Roorkee (IN); Smruti Prakash BARIK, Roorkee (IN); Rajiv Ranjan SRIVASTAVA, Roorkee (IN); Bhuvnesh KUMAR, Roorkee (IN)

(21) Appl. No.: 18/862,957

(22) PCT Filed: May 5, 2023
(86) PCT No.: PCT/IB2023/054684

§ 371 Date: Nov. 5, 2024

(30) Foreign Application Priority Data
May 5, 2022 (IN) 202211026296

(51) Int. Cl. H01M 10/54; H01M 50/691

(52) U.S. Cl. CPC H01M 10/54; H01M 50/691; H01M 2300/002

(57) ABSTRACT

The present invention relates to a method of removing and safe disposal of electrolyte from all types of spent lithium ion batteries in a commercially feasible manner. Electrolyte, lithium hexafluorophosphate (LiPF6) is highly soluble in water and thus is removed from the spent LIBs during shredding in presence of water. In aqueous solution, LiPF6 is greatly dissociated into its ions and formation of HF is more likely. This method is simple to operate and easy to scale up. This method provides greater recovery yielding 99.7%, 63.4% and 75.5% for fluorine (F), lithium (Li) and phosphorous (P), respectively. Additionally, the method is clean, green and environment friendly.

### FIELD OF THE INVENTION

The present invention relates to removal and disposal of electrolyte from spent lithium ion batteries. More particularly, the present invention relates to an environment friendly method for removing and disposing electrolyte safely from all types of spent lithium-ion batteries in a commercially feasible manner.

### BACKGROUND OF THE INVENTION

Lithium ion batteries (LIBs) have been extensively used worldwide as an important energy storage and conversion devices to power portable electronic devices and electric vehicles due to high voltage, high energy density, high specific energy, small size, good capacity retention, small self-discharge rate, zero memory effect, wide operating temperature range and long life-cycle. Hence, LIBs have been applied over a wide range of application for example in laptops, video cameras, mobile phones, electronic vehicles and other mobile electronics and biological instruments.

Since batteries do have a lifespan which is not long enough and at present average life of LIBs range from a year to three, depending on which technology is being used. Spent LIBs have been categorized as waste which is not environmentally compatible or friendly. The existence of toxic and flammable elements or compounds in batteries may become hazardous and cause serious problem to environment if not disposed safely.

It is predicted that, in future years, the amount of waste LIBs will increase with the market expansion and productivity growth of LIBs. Owing to the increasing pressure on ecological effect of solid waste disposal and developing need for disposing of corresponding hazardous metals, recovery of spent lithium ion batteries (LIBs) have gained worldwide attention in recent years. Lot of work has been done in this regard in past few decades and several new, interesting and unique methods have been developed to recycle cathode, anode and electrolyte.

Recycling could be a promising strategy in the future due to high desirability of valuable products, which is beneficial from both economic and environmental perspectives. Recycling has several advantages for example it can help to reduce the environmental toxicity from the production of virgin materials and reduction in the mining of natural resources.

The major challenge regarding an inappropriate handling of waste materials from spent LIBs is disposal of electrolyte. As electrolyte is among one of the main component of LIBs, for this reason it should not be ignored. However, electrolyte containing different lithium salts and volatile organic compounds have adverse impacts to human health and environment, therefore to prevent severe threats produced by toxic, inflammable, volatile and hazardous compounds of electrolytes it is also important to focus research on the electrolyte extraction. In the recent few years, researchers have paid much attention on recycling electrolytes. Several researchers adopted different techniques for the recycling of electrolyte apart from solvent extraction which is considered to be the first most efficient method to recover electrolyte.

WO2014/155784 disclosed method for processing fluorine containing electrolyte solution and characterized by comprising: a vaporization step wherein the volatile component of an electrolyte solution that contains a fluorine compound vaporized by heating the electrolyte solution at reduced pressure; a fluorine immobilization step wherein the fluorine component contained in the vaporized gas reacted with calcium so as to be immobilized in the form of calcium fluoride; and an organic solvent component recovered.

JP3257774 discloses treating method of organic electrolyte containing lithium hexafluorophosphate and relates to a technique for industrially recycling lithium hexafluorophosphate compounds separated as hexafluorophosphate and lithium fluoride by using solution comprising of primary, secondary and tertiary alcohols and an agent like potassium or ammonium fluoride.

WO201546218A1 disclosed method for treating fluorine-containing liquid electrolyte and relates to vaporization step in which water is added to a fluorine containing liquid electrolyte and heated to vaporize a volatile component and a gas resulting from the vaporization was recovered; and fluorine in either the aforementioned gases or a condensate of gases reacted with calcium and fixated in the form of calcium fluoride, and an organic solvent component recovered.

Over the years, few other methods of removing and disposing electrolyte were also reported but none of the reported method in those documents disclose about the method that is easy to operate and that do not involve use of any sophisticated equipment and is free from any harsh chemicals.

Therefore, there is a need for an approach that resolves problems of state of art to provide a simple process for removing and disposing electrolyte safely in a commercially feasible method without polluting/harming the environment. The present invention is an endeavor to that direction.

### OBJECT OF THE INVENTION

The main object of the present invention is to provide a method of removing and safe disposal of electrolyte from spent lithium-ion batteries.

Another object of the present invention is to provide a method of removing and disposing electrolyte safely from all types spent lithium-ion batteries in a commercially feasible method.

Yet another object of the present invention is to provide a method that is simple in operation and easy to scale up.

Yet another object of the present invention is to provide a method that does not require use of any sophisticated equipment.

Still another object of the present invention is to provide a method, which is simple, clean, green and environment friendly.

### SUMMARY OF THE INVENTION

The present invention relates to a method of removing and safe disposal of electrolyte from spent lithium ion batteries by physical processes like heating, agitation, precipitation and filtration.

In an embodiment, the present invention provides a method of removing and safe disposal of electrolyte from spent lithium-ion batteries, comprising the steps of: a) removing highly soluble electrolyte from spent lithium ion battery during shredding in presence of water to obtain an electrolyte solution; b) heating the electrolyte solution of step a) with a suitable precipitating agent for fluoride precipitation at a temperature range of 70-90° C., under agitation at 100 rpm in a closed reactor for a pre-determined time to obtain a first slurry; c) filtering the first slurry obtained in step (b) and collecting and analysing both precipitated mass (cake) and filtrate for metal ions separately; d) analysing the filtrate collected in step (c) for determining a concentration of fluoride ions, lithium and phosphorous; e) treating the analyzed filtrate of step (d) with charcoal followed by agitating with another precipitating agent which is trisodium phosphate (20% w/v) at 90-100° C. for 3-4 hours to obtain a second slurry; f) filtering the second slurry of step e) and collecting a precipitated cake of lithium phosphate and filtrate separately; g) washing and drying the precipitated cake of lithium phosphate of step f) with hot water to get pure lithium phosphate; and h) evaporating and crystallising the filtrate of step f) and recovering condensate water and trisodium phosphate crystals for reuse.

The present invention relates to an environment friendly method for removing and disposing electrolyte safely from all types spent lithium-ion batteries in a commercially feasible manner.

The above objects and advantages of the present invention will become apparent from the hereinafter set forth brief description of the drawings, detailed description of the invention, and claim appended herewith.

### BRIEF DESCRIPTION OF THE DRAWING

An understanding of the method of removing and safe disposal of electrolyte from spent lithium-ion batteries of the present invention may be obtained by reference to the following drawings:

FIG. 1 is a schematic representation of process flow for treatment of waste electrolyte depicting the method of removing and safe disposal of electrolyte from spent lithium-ion batteries waste electrolyte according to an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

The present invention now will be described hereinafter with reference to the detailed description, in which some, but not all embodiments of the invention are indicated. Indeed, the invention may be embodied in many different forms and should not be construed as limited to the embodiments set forth herein; rather, these embodiments are provided so that this disclosure will satisfy applicable legal requirements. Like numbers refer to like elements throughout. The present invention is described fully herein with non-limiting embodiments 20 and exemplary experimentation.

The present invention relates to the method for removal and safe disposal of electrolyte from spent lithium ion batteries by physical processes like heating, agitation, precipitation and filtration.

In a preferred embodiment, the present invention provides a method for removal and safe disposal of electrolyte from spent lithium ion batteries, comprising the steps of: a) removing highly soluble electrolyte from spent lithium ion battery during shredding in presence of water to obtain an electrolyte solution; b) heating the electrolyte solution of step a) with a suitable precipitating agent for fluoride precipitation at a temperature range of 70-90° C., under agitation at 100 rpm in a closed reactor for a pre-determined time to obtain a first slurry; c) filtering the first slurry obtained in step (b) and collecting and analysing both precipitated mass (cake) and filtrate for metal ions separately; d) analysing the filtrate collected in step (c) for determining a concentration of fluoride ions, lithium and phosphorous; e) treating the analyzed filtrate of step (d) with charcoal followed by agitating with trisodium phosphate (20% w/v) at 90-100° C. for 3-4 hours to obtain a second slurry; f) filtering the second slurry of step e) and collecting a precipitated cake of lithium phosphate and filtrate separately; g) washing and drying the precipitated cake of lithium phosphate of step f) with hot water to get pure lithium phosphate; and h) evaporating and crystallising the filtrate of step f) and recovering condensate water and trisodium phosphate crystals for reuse.

Further, drying the precipitated mass of step (c) overnight at a temperature range of 60-90° C. and analysing the dried precipitated mass to determine precipitation efficiency of fluoride.

Here, the electrolyte of step a) is lithium hexafluorophosphate (LiPF₆), the predetermined time in step b) is 3-5 hours and the suitable precipitating agent in step b) is 50% w/v lime. The closed fibre-reinforced plastic (FRP) reactor is used for maintaining high temperature. The analysed filtrate of step (d) is having the concentration of 2.23 g/L lithium and 11.88 g/L phosphorous, respectively and is free of fluoride ion having the concentration of 18 ppm. The recovered condensate water and trisodium phosphate crystals in step h) are reutilised in the method.

The precipitation efficiency of fluoride in step i) is 99.4%. The precipitated cake of lithium phosphate in step g) is having precipitation efficiency of 58.2% for Li and 66.8% for P.

The method of the present invention provides recovery of 99.7% fluorine (F), 63.4% lithium (Li) and 75.5% phosphorous (P) from the lithium hexafluorophosphate electrolyte of the spent lithium ion battery.

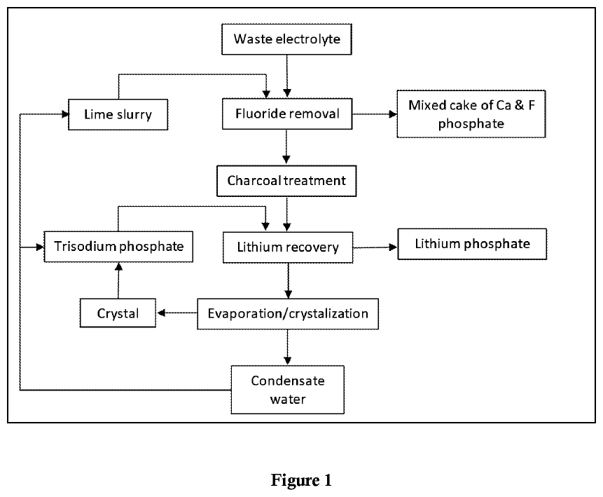

FIG. 1 shows a process flow for treatment of waste electrolyte depicting the method of removing and safe disposal of electrolyte from spent lithium-ion batteries waste electrolyte according to an embodiment of the present invention.

### Example 1

### Elemental Analysis

The elemental analysis for metals in the electrolyte was conducted using microwave plasma atomic emission spectrometer (MP-AES), while the fluoride concentration in solution was analyzed using ORION Dual Star (equipped with fluoride electrode) at room temperature i.e., 25° C. The analysis result shows 98 g/L P, 11.5 g/L Li, and 46 g/L F in the original solution.

To the electrolyte, lime was added at different stoichiometric ratios and temperature of 25° C. as shown in Table 1. The slurry was allowed to mix at an agitation of 400 rpm for the next 2 hours. Finally, the slurry was filtered with the help of Buchner funnel to separate the cake (precipitated mass) and filtrate followed by the analysis of the filtrate.

TABLE 1
Fluoride removal efficiency by precipitation with lime at different
stoichiometric dosages added to 1 L electrolyte solution

| | | | | Elements | | |
|---|---|---|---|---|---|---|
| Entry | Stoichiometric | | Sample | analyzed | | |
| no. | lime dosage | UOM | type | P | Li | F |
| a. | Zero | g/L | Original | 96 | 11.3 | 46 |
| | | | solution | | | |
| b. | 1.5 times | g/L | Filtrate | 29.1 | 5.9 | 0.04 |
| c. | 2.0 times | g/L | Filtrate | 35.9 | 5.4 | 0.06 |
| d. | 4.0 times | g/L | Filtrate | 34.7 | 5.7 | 0.06 |

### Example-2

### Effect of Heat Treatment

The effect of heat treatment on the liberation of fluoride ions from the electrolyte was examined by varying the solution temperature up to 90° C. for 5 hours. It was observed that the temperature has a significant role in liberating the fluoride ions from the LiPF₆ compound, resulting in an increased concentration of fluoride ions in the electrolyte solution, and was analyzed by a fluoride electrode. The analysis result is summarized in Table 2 show a significant difference in fluoride-ion concentration between the solutions of pre- and post-heating.

TABLE 2
Effect of heat treatment on the liberation of fluoride-
ion concentration in electrolyte solutions

| | | | Elements analyzed | | |
|---|---|---|---|---|---|
| S. No | Temperature | UOM | P | Li | F |
| a. | 25° C. | g/L | 98 | 11.5 | 37 |
| b. | 65° C. | g/L | 102 | 11.8 | 62 |
| c. | 90° C. | g/L | 110 | 12.1 | 132 |

### Example-3

### Precipitation Behavior

1.0 L of the original electrolyte was heated at 88 (+2° C.) for 5 h to completely liberate the fluoride ions from the LiPF₆ compound to the aqueous phase. The concentration of the final solution after heat treatment was cooled to room temperature and analyzed to be 110 g/L P, 12.1 g/L Li, and 132 g/L F. Subsequently, lime at a 4-folds higher dosage than the stoichiometric requirement was added to the solution at room temperature and continued for 3 hours. Finally, the slurry was filtered, and both the filtrate and precipitated mass were analyzed. The details are as shown in Table 3. About 99.4% of fluoride along with 58.2% of Li and 66.8% of P was also co-precipitated, while 18 ppm of F, 2.23 g/L of Li, and 11.88 g/L of P remained in the filtrate. Now the filtrate either can be disposed off safely or be further used to recover the valuable lithium and phosphorous.

TABLE 3
The precipitation behavior with the mass balance of fluoride
ions from the heat-treated electrolyte solution

| Entry | Experiment | | Sample | Elements analyzed | | |
|---|---|---|---|---|---|---|
| no. | details | UOM | type | P | Li | F |
| a. | 88(±2)° C. | g/L | Initial | 110 | 12.1 | 132 |
| | | Abs. g | solution | 110 | 12.1 | 132 |
| | | | (1 L vol.) | | | |
| b. | Precipitation | g/L | Filtrate | 11.88 | 2.23 | 0.018 |
| | with lime | Abs. g | (700 mL | 8.32 | 1.56 | 0.13 |
| | (Dry wt., | | vol.) | | | |
| | 310 g) | % | Precipitated | 14 | 1.34 | 25 |
| | | Abs. g | mass | 73.5 | 7.03 | 131.25 |
| | | | (Dry wt., | | | |
| | | | 525 g) | | | |

### Example-4

### Experimentation

### Batch 1

In a batch 1, 200 ml of the waste electrolyte was agitated with 150 ml of lime slurry (50% w/v) for 3 hours at 70° C. The slurry was allowed to cool and filtered. The filtrate (230 ml) and cake (140 g) were collected. The filtrate 1 (230 ml) was further taken for lithium recovery after passing through a carbon column containing 100 g of activated charcoal (Iodine value>900 mg/kg). The lithium recovery was done by agitating the liquor with 100 ml of trisodium phosphate solution (20% w/v) at 90° C. for 3 hours. The slurry was filtered and the cake was washed with hot water and then dried to get pure lithium phosphate (12 g). The analysis of samples i.e., waste electrolyte, filtrate 1, cake and lithium phosphate were done by using MP-AES (Microwave Plasma Atomic Spectro Photometer) for Li, P and Ca whereas F was determined by using ion selective electrode and presented in Table 4.

TABLE 4
Chemical analysis of the samples in batch 1

| | | Elements | | | |
|---|---|---|---|---|---|
| Sample detail | Unit | Li | P | F | Ca |
| Waste electrolyte | g/L | 12.1 | 98.4 | 133 | BDL |
| Filtrate 1 | g/L | 9.8 | 10.3 | 0.05 | 0.21 |
| Cake | % | 0.11 | 14.7 | 25.2 | 26 |
| Lithium phosphate | % | 18.01 | 26.1 | BDL | BDL |

### Batch 2

In a batch 2, 2 L of the waste electrolyte was agitated with 1.48 L of lime slurry (50% w/v) for 3 hours at 70° C. The slurry was allowed to cool and filtered. The filtrate (2.21 L) and cake (1.38 kg) were collected. The filtrate 1 (2.21 L) was further taken for lithium recovery after passing through a carbon column containing 1 kg of activated charcoal (Iodine value>900 mg/kg). The lithium recovery was done by agitating the liquor with 1 L of trisodium phosphate solution (20% w/v) at 90° C. for 3 hours. The slurry was filtered and the cake was washed with hot water and then dried to get pure lithium phosphate (118 g). The analysis of samples i.e., waste electrolyte, filtrate 1, cake and lithium phosphate were done by using MP-AES (Microwave Plasma Atomic Spectro Photometer) for Li, P and Ca whereas F was determined by using ion selective electrode and presented in Table 5.

TABLE 5
Chemical analysis of samples in batch 2

| | | Elements | | | |
|---|---|---|---|---|---|
| Sample detail | Unit | Li | P | F | Ca |
| Waste electrolyte | g/L | 12.3 | 98.8 | 142 | BDL |
| Filtrate 1 | g/L | 10.2 | 9.1 | 0.05 | 0.25 |
| Cake | % | 0.13 | 13.1 | 20.4 | 26.2 |
| Lithium phosphate | % | 18.06 | 26 | BDL | BDL |

Therefore, the present invention provides a method of removing and disposing electrolyte safely from all types of spent lithium-ion batteries in a commercially feasible manner. The environment friendly method of the present invention provides greater recovery yielding 99.7%, 63.4% and 75.5% for fluorine (F), lithium (Li) and phosphorous (P), respectively.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A method of removing and safe disposal of electrolyte from spent lithium-ion batteries, characterized in that, the method comprising the steps of:
a) removing highly soluble electrolyte from spent lithium ion battery during shredding in presence of water to obtain an electrolyte solution;
b) heating the electrolyte solution of step a) with a suitable precipitating agent for fluoride precipitation at a temperature range of 70-90° C., under agitation at 100 rpm in a closed reactor for a pre-determined time to obtain a first slurry;
c) filtering the first slurry obtained in step (b) and collecting and analysing both precipitated mass (cake) and filtrate for metal ions separately;
d) analysing the filtrate collected in step (c) for determining a concentration of fluoride ions, lithium and phosphorous;
e) treating the analyzed filtrate of step (d) with charcoal followed by agitating with another precipitating agent which is trisodium phosphate (20% w/v) at 90-100° C. for 3-4 hours to obtain a second slurry;
f) filtering the second slurry of step e) and collecting a precipitated cake of lithium phosphate and filtrate separately;
g) washing and drying the precipitated cake of lithium phosphate of step f) with hot water to get pure lithium phosphate; and
h) evaporating and crystallising the filtrate of step f) and recovering condensate water and trisodium phosphate crystals for reuse.

2. The method of removing and safe disposal of electrolyte from spent lithium-ion batteries as claimed in claim 1, wherein the electrolyte of step a) is lithium hexafluorophosphate (LiPF₆).

3. The method of removing and safe disposal of electrolyte from spent lithium-ion batteries as claimed in claim 1, wherein the pre-determined time in step b) is 3-5 hours.

4. The method of removing and safe disposal of electrolyte from spent lithium-ion batteries as claimed in claim 1, wherein the suitable precipitating agent in step b) is 50% w/v lime.

5. The method of removing and safe disposal of electrolyte from spent lithium-ion batteries as claimed in claim 1, wherein the analysed filtrate of step (d) is having the concentration of 2.23 g/L lithium and 11.88 g/L phosphorous, respectively and is free of fluoride ion having the concentration of 18 ppm.

6. The method of removing and safe disposal of electrolyte from spent lithium-ion batteries as claimed in claim 1, wherein the precipitated cake of lithium phosphate in step g) is having precipitation efficiency of 58.2% for Li and 66.8% for P.

7. The method of removing and safe disposal of electrolyte from spent lithium-ion batteries as claimed in claim 1, wherein the recovered condensate water and trisodium phosphate crystals in step h) are reutilised.

8. The method of removing and safe disposal of electrolyte from spent lithium-ion batteries as claimed in claim 1, wherein the method recovers 99.7% of fluorine (F), 63.4% of lithium (Li) and 75.5% of phosphorous (P).
